(19) United States
(12) Patent Application Publication
(10) Pub. No.: US 2005/0244047 A1
(43) Pub. Date: Nov. 3, 2005

(54) STOP MOTION IMAGING DETECTION SYSTEM AND METHOD

(75) Inventors: Frederick W. Kern Jr., Colchester, VT (US); Paul A. Manfredi, Waterbury Center, VT (US); Douglas P. Nadeau, Underhill, VT (US)

Correspondence Address: CONNOLLY BOVE LODGE & HUTZ LLP;IBM MICROELECTRONICS DIVISION, 1990 M STREET NW, SUITE 800, WASHINGTON, DC, 20036-3425, US

(73) Assignee: INTERNATIONAL BUSINESS MACHINES CORPORATION, Armonk, NY (US)

(21) Appl. No.: 10/709,315

(22) Filed: Apr. 28, 2004

(51) Int. Cl. G06K 9/00

(52) U.S. Cl. 382/141

(57) ABSTRACT

A system and method implemented by the system controls a process acting on a moving object by providing a plurality of “stop-action” reference images of a feature of a reference object. The plurality of reference images represent a range of periodic process results relating to the feature at various process sample times. While the process is acting on the moving object, a first image of a feature of the moving object at a first sample time is obtained, and the first image is compared to one or more of the plurality of reference images, which may represent various nominal and out of tolerance process conditions. From this comparison, the necessity for making a process adjustment of one or more process parameters of the process acting on the moving object is determined, and process control may be essentially effected in real time.

### BACKGROUND OF INVENTION

This invention relates to image analysis, and more particularly relates to image analysis of objects in motion, and even more particularly relates to analysis of objects in motion in the context of real-time manufacturing process monitoring and control.

Image analysis has proven to be a useful tool in the evaluation of equipment performance, including real-time process control. In a manufacturing setting, image analysis has not been applied to systems in motion, due to the difficulty in obtaining images that depict the object or objects undergoing analysis as stationary objects within the same orientation.

For example, during chemical-mechanical polishing (CMP) of a semiconductor substrate, proper polishing of a wafer may generally be judged visually when the process is stopped, but is impossible to observe in real time, due to wafer movement. Similarly, photoresists are commonly used to coat semiconductor wafers. Determination of the uniformity of the resist coating requires stopping of the coating process, which may not be complete, or which may have applied more resist than necessary, or which may have non-uniformly coated the wafer with resist.

The ability to image and analyze an object of manufacture during a manufacturing process involving motion could enhance manufacturing capabilities and production yield. What is needed then is a system which provides the ability to obtain and analyze images of moving objects, and what is further needed is a system, method, and manufacturing tool which provides the ability to obtain and analyze images of moving objects for use in real-time manufacturing process control including, for example, CMP processing and coating of semiconductor wafers.

### SUMMARY OF INVENTION

Various embodiments of the invention provide increased reliability for end point detection of various manufacturing processes by adding visual means of reference, and control of conventional end-point technologies.

For example, in one embodiment, a system for real-time process control of a manufacturing process operating on a moving object includes an image capturing device; a light source; a memory device storing a plurality of reference images corresponding to at least two process conditions at associated sample times; and a processor operatively connected to the image capturing device, the light source, and the memory device, wherein the processor strobes the light source and actuates the image capturing device to capture an image of a feature of the moving object at a periodicity corresponding to a movement of the moving object, wherein the processor compares the captured image to one or more of the stored plurality of reference images in the memory device, and wherein the processor controls the manufacturing process operating on the moving object based upon changes to the feature during the manufacturing process.

In another aspect of this embodiment, a manufacturing tool includes a device which performs a process on an object of manufacture so as to cause a periodic movement of the object during the process; a controller operatively coupled to the device; a photo-stroboscopic camera which captures an image of a feature of the object during the process; a memory device storing a plurality of reference images corresponding to two or more process conditions at associated sample times; and a processor coupled to the photo-stroboscopic camera and the memory device, wherein the processor actuates the photo-stroboscopic camera at intervals corresponding to a period of the periodic movement of the object so as to provide a series of constant orientation images of the feature, wherein the processor determines changes to the feature during the process based upon a comparison between one or more of the series of constant orientation images and at least one of the stored plurality of reference images, and wherein the processor communicates with the controller based upon the comparison and commands an adjustment of the process performed by the device on the object of manufacture.

In another embodiment of the invention, method for controlling a process acting on a moving object which includes providing a plurality of reference images of a feature of a reference object, the plurality of reference images representing a range of process results corresponding to a first sample time; obtaining, while the process is acting on the moving object, a first image of a feature of the moving object at a time corresponding to the first sample time; and comparing the first image to one or more of the plurality of reference images and determining, based upon the comparison result, a necessary process adjustment of one or more process parameters of the process acting on the moving object.

Further scope and applicability of the disclosure will become apparent from the detailed description given hereinafter. However, it should be understood that the detailed description and specific examples, while indicating various embodiments and aspects of the invention, are given by way of illustration only, since various changes and modifications within the spirit and scope of the invention will become apparent to those skilled in the art from this detailed description.

### BRIEF DESCRIPTION OF DRAWINGS

FIG. 1 illustrates a block diagram of a stop-motion imaging detection system of an embodiment of the invention which may be used to control a monitored process; and

FIG. 2 provides an exemplary flowchart of a method relating to operation of the system of FIG. 1.

### DETAILED DESCRIPTION

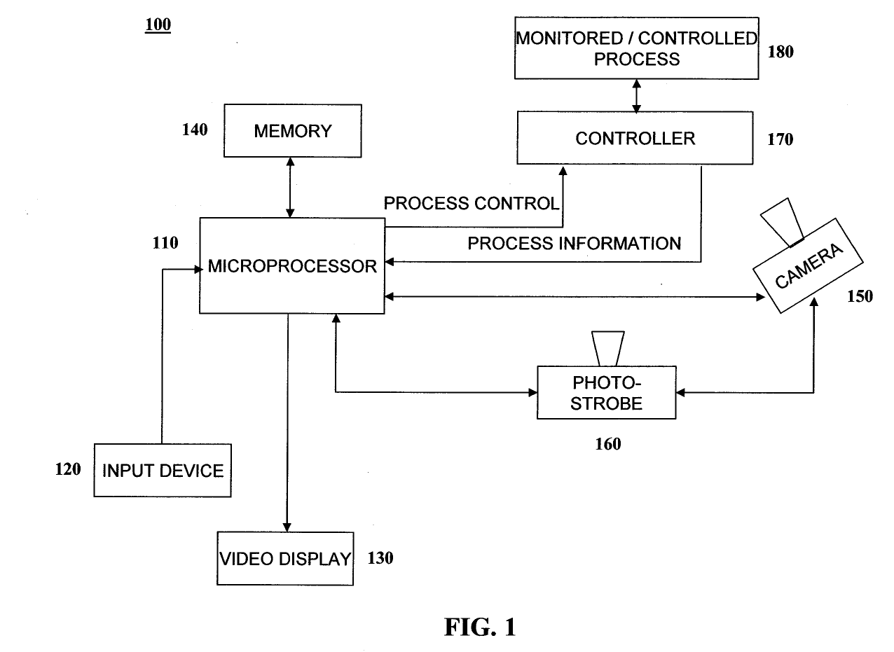

One embodiment of the invention will now be described with respect to the system block diagram of FIG. 1.

System 100 includes microprocessor 110, input device 120, video display 130, memory 140, camera 150 and photo-strobe 160.

Microprocessor 110 may be a personal computer or a special purpose processor. Microprocessor 110 receives input from input device 120, which may be a keyboard or a network connection such as a LAN, for example, which provides input from an external source, not shown. Microprocessor 110 also provide an video output to video display 130, which may be a standard CRT or LCD, for example. Memory 140 is coupled to microprocessor 110, and may include one or more random access memories (RAM), or a combination of read-only memory (ROM) and RAM. Microprocessor 110 may also use a hard disk drive, not shown, for storage of data.

Microprocessor 110 receives input from, and provides control signals to photo-strobe 160, and to video camera 150. Video camera 150 may be a digital camera, which is electrically triggered by photo-strobe 160.

In another aspect of the embodiment of FIG. 1, a manufacturing tool for controllably performing a manufacturing process on a moving object includes the components of system 100 described above, but further encompasses manufacturing process 180 operating on a moving object and controller 170, which is operatively connected between microprocessor 110 and manufacturing process 180. Camera 150 is oriented to include a surface or other aspect of the moving object within the field of view of camera 150, and which is of interest in using to monitor and/or control manufacturing process 180.

Manufacturing process 180 is monitored and controlled by system 100, and may include, for example, a chemical-mechanical polishing (CMP) process operating on a substrate; a resist coating process applied to a semiconductor substrate; and other manufacturing processes which involve motion of a nature which make conventional real-time process measurement techniques difficult, if not impossible.

Process parameter information from process 180 may include, for example, the periodicity of a repetitive or moving process, the pressure of a polishing pad and/or rotational speed, or a flow rate of a coating material that is provided to microprocessor 110 through one or more data lines, either directly, or through controller 170.

Microprocessor 110 repeatedly causes photo-strobe 160 and camera 150 to operate in a synchronized fashion, based upon the periodicity of the motion of process 180. The resulting series of pictures taken by camera 150 are displayed on video display 130, and may be stored in memory 140. By synchronizing photo-strobe 160 and camera 150 with the periodicity of process 180, the resulting series of pictures appears stationary on video display 130, i.e., in “stop-action” where the motion of process 180 appears to be “frozen”. Such a stationary image allows imaging of a surface or other feature of the moving object being operated upon by process 180. Subsequently, measurement of a feature or surface parameter may be accomplished using the stationary image, using known techniques.

After imaging of a desired parameter at a particular process reference time, for example, by obtaining an image of a surface being acted upon by process 180 at a particular elapsed time of the process, the surface image data may be catalogued for display or analysis. Standard image data formats may be employed, e.g., JPG or TIF formats.

In analyzing such an image, the image may be compared to multiple reference images stored in memory 140 representing nominal or “known good” parameter values or results representing the same relative process reference time. These multiple reference images are stored in a memory, and may be further stored in memory in a database structure. Such reference images may include images representing both below and above nominal conditions. Depending upon the particular process and end-use specification to be met by the process, deviations considered to be too far from the nominal value may be categorized as representing an unacceptable result.

If the image of the object being operated upon by process 180 is still within acceptable limits with respect to the particular reference r sample time, process 180 may be allowed to continue in operation. Another sequential image from camera 150 may be obtained at a different relative process time, and compared to corresponding reference images in memory 140 associated with that same relative process time.

Since images may be obtained very rapidly, essentially in real-time, process 180 may be monitored in real-time by comparison of the stationary or “frozen” image at successive, periodic process sample times with reference images which are correlated to the process sample times. In this way, as the object being acted upon by process 180 approaches the acceptable limit of the particular feature being measured, the operator or automated process may be warned of any impending unacceptable result before it is too late to take corrective action. This would aid in increasing the manufacturing yield of semiconductor chips, for example.

Microprocessor 110 may further provide one or more control signals, in response to the periodic image analysis, to process 180 via controller 170 to effect a change in a process parameter, e.g., rotational speed and/or polishing pad pressure, or flow rate of a coating material, for example.

Chemical-mechanical polishing of a wafer is an example application of process control which can benefit from the various embodiments and aspects of the invention.

Although proper polishing of a semiconductor wafer by CMP may be judged visually if wafer movement is stopped, proper conventional polishing is impossible to observe in real time because of wafer movement. The embodiment discussed above creates sequential stop motion images that can be analyzed in real time to produce real time process control by comparing the actual image at any given process sample time with stored reference images to determine the progress of the CMP process as a function of time. Further, polishing pad pressure and/or rotational speed may be adjusted in real time to minimize variations in center top edge polishing rates. If the analysis and comparison of the real time image with the reference images indicates that the process is not appropriately controlled, an audible and/or visual alarm may be provided, and the process may be stopped or otherwise adjusted.

If the image of the wafer currently being processed falls within the nominal limits of comparison, then processing proceeds unchanged to the next check interval or sample time. If the image of the wafer currently undergoing processing corresponds to that of a finished wafer, the process may be halted. If, during the processing cycle, any comparison made to the “library” of reference images falls outside the established parameters can be classified as an alarm state.

Semiconductor manufacturers know that changes to mechanical or chemical forces during the CMP process will change the overall polishing results. By comparative analysis in real time and controlling the forces either mechanically or chemically-induces during the polishing process, recovery adjustments can be made while referencing the library of images based on developed recovery parameters, thus allowing for real time process monitoring and adjustment.

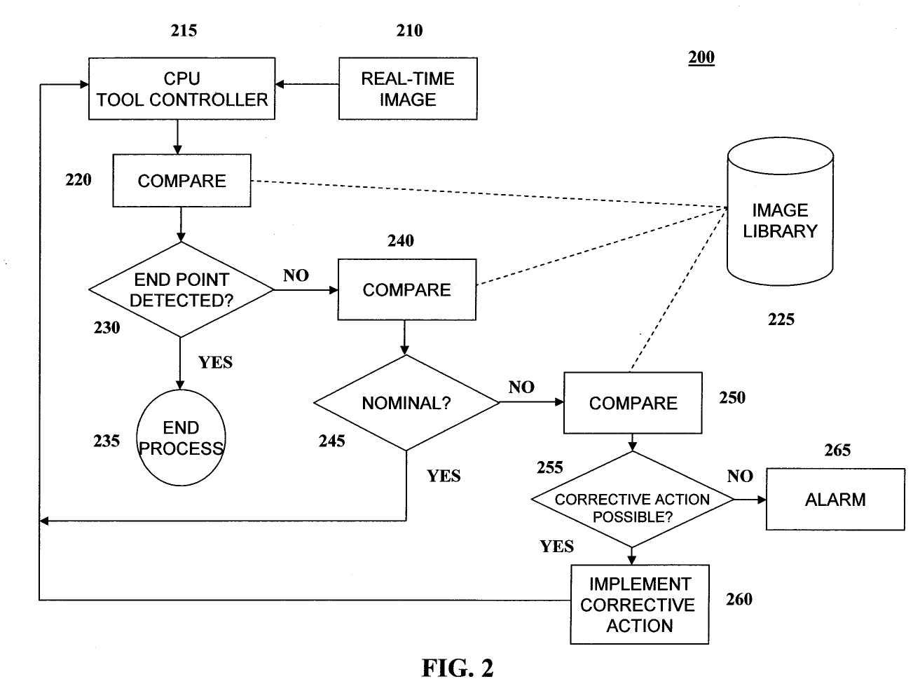

Turning now to FIG. 2, a functional block diagram/decision tree or flowchart depicting a method of an embodiment of the invention is depicted.

Method 200 includes obtaining real time image 210, and providing image 210 to tool controller 215, and then conducting a comparison operation 220 between one or more features shown in image 210 and the same feature(s) shown in one or more reference images stored in image library 225. These reference images represent an end point of the process. If a process end point is detected at step 230, the process is ended at step 235. However, if the end point is not detected, a further comparison is made at step 240 with one or more images from image library 225 which represent nominal values of the object feature being monitored and/or controlled.

If, at step 245, the process is determined to still be within nominal limits, tool controller 215 is allowed to continue operating. If the object feature or process is determined to be out of the nominal range, a further comparison of the object feature with out-of-nominal reference images from image library 225 is made at step 250. If, at decision point 255, it is determined that corrective action is not possible, then an alarm is actuated at step 265. If corrective action is possible, then corrective action is implemented in step 260 on tool controller 215 in an attempt to drive the process and object feature back into nominal limits. This control scheme continues until either the end point of the process is encountered, or until it is determined that corrective action is no longer possible.

It will be obvious that the various embodiments and aspects of the invention may be varied in many ways. Such variations are not to be regarded as a departure from the spirit and scope of the disclosure, and all such modifications as would be obvious to one skilled in the art are intended to be included within the scope of the following claims. The breadth and scope of the disclosed invention is therefore limited only by the scope of the appended claims and their equivalents.

1. A method for controlling a process acting on a moving object, the method comprising:
providing a plurality of reference images of a feature of a reference object, the plurality of reference images representing a range of process results corresponding to a first sample time;
obtaining, while the process is acting on the moving object, a first image of a feature of the moving object at a time corresponding to the first sample time; and
comparing the first image to one or more of the plurality of reference images and determining, based upon the comparison result, a necessary process adjustment of one or more process parameters of the process acting on the moving object.

2. The method of claim 1, wherein said obtaining the first image includes using a photo-stroboscopic technique.

3. The method of claim 1, wherein said plurality of reference images includes images representing each of a below nominal and an above nominal process result pertaining to the feature.

4. The method of claim 1, further comprising, after said comparing and determining, providing an essentially real-time adjustment of said one or more process parameters of the process acting on the moving object.

5. The method of claim 1, further comprising, after said comparing and determining, stopping the process acting on the moving object.

6. The method of claim 1, wherein said comparing includes determining periodic changes to the feature while the process is acting on the moving object.

7. The method of claim 1, wherein said process acting on the moving object includes a CMP process operating on a substrate.

8. The method of claim 1, wherein said process acting on the moving object includes coating a semiconductor wafer with a resist.

9. A system for real-time process control of a manufacturing process operating on a moving object, the system comprising:
an image capturing device;
a light source;
a memory device storing a plurality of reference images corresponding to at least two process conditions at associated sample times; and
a processor operatively connected to the image capturing device, the light source, and the memory device,
wherein the processor strobes the light source and actuates the image capturing device to capture an image of a feature of the moving object at a periodicity corresponding to a movement of the moving object,
wherein the processor compares the captured image to one or more of the stored plurality of reference images in the memory device, and
wherein the processor controls the manufacturing process operating on the moving object based upon changes to the feature during the manufacturing process.

10. The system of claim 9, further comprising a video display device controlled by the processor and configured to receive an image from either the image capturing device or the memory device, or both, wherein the video display device receives the image at a refresh rate equal to the periodicity corresponding to the movement of the moving object.

11. The system of claim 9, wherein the processor stops the manufacturing process operating on the moving object based upon the comparison of the captured image to the one or more of the stored plurality of images in the memory device.

12. The system of claim 9, wherein the manufacturing process controlled by the processor is a CMP process operating on a substrate.

13. The system of claim 9, wherein the manufacturing process controlled by the processor comprises coating a wafer with a resist.

14. A manufacturing tool, comprising:
a device which performs a process on an object of manufacture so as to cause a periodic movement of the object during the process;
a controller operatively coupled to the device;
a photo-stroboscopic camera which captures an image of a feature of the object during the process;
a memory device storing a plurality of reference images corresponding to two or more process conditions at associated sample times; and
a processor coupled to the photo-stroboscopic camera and the memory device,
wherein the processor actuates the photo-stroboscopic camera at intervals corresponding to a period of the periodic movement of the object so as to provide a series of constant orientation images of the feature,
wherein the processor determines changes to the feature during the process based upon a comparison between one or more of the series of constant orientation images and at least one of the stored plurality of reference images, and
wherein the processor communicates with the controller based upon the comparison and commands an adjustment of the process performed by the device on the object of manufacture.

15. The manufacturing tool of claim 14, wherein the device is a polishing tool and the process is a CMP process.

16. The manufacturing tool of claim 15, wherein the processor commands an adjustment of a CMP process.

17. The manufacturing tool of claim 14, wherein the plurality of reference images are stored in the memory device in a database structure.
